(19) United States
(12) Patent Application Publication
(10) Pub. No.: US 2004/0258416 A1
(43) Pub. Date: Dec. 23, 2004

(54) Reflective optical apparatus for free-space optical communicating system

(76) Inventor: Kelson Yen, Taichung (TW)

Correspondence Address: DELLETT AND WALTERS, P. O. BOX 2786, PORTLAND, OR, 97208-2786, US

(21) Appl. No.: 10/602,474

(22) Filed: Jun. 23, 2003

(51) Int. Cl. H04B 10/00

(52) U.S. Cl. 398/128

(57) ABSTRACT

A reflective optical apparatus for a free-space optical communication system includes a housing, an optical transceiver, a reflective member and the protective window. The housing has a front opening. The reflective member is mounted in the housing and has a reflective surface with a focal point, which faces the front opening. The optical transceiver is mounted at the focal point of the reflective surface. The protective window is mounted in the housing between the transceiver and the front opening of the housing. Consequently, the reflective member can be made of machinable materials, such as composite materials and can be machined precisely to form the reflective surface with an exact curvature and smooth surface. The materials and sizes of the reflective member are not restricted, and the objectives of being low cost and easy to machine in fabrication for the reflective optic apparatus are accomplished.

### BACKGROUND OF THE INVENTION

1. Field of the Invention

The present invention relates to an optical apparatus for a free-space optical communicating system, and more particularly to a reflective optical apparatus for a free-space optical communicating system.

2. Description of Related Art

With the growth of the Internet, wireless communication technology is set to be the fastest growing technology in recent years. The Internet consists of lots of local area networks (LAN) that communicate mutually with each other. Typically, optical fiber, coaxial cables or wires are the media used to connect two individual networks together. However, installing the optical fiber, coaxial cables or wire is generally time consuming and expensive.

Wireless communication technology is more convenient to install than conventional media. Free-space optical technology (FSO) provides a wireless communication environment with optical fiber like speed of data or information transfer. With reference to FIG. 2, free-space optical technology can be used to link communication systems in a building A (60) and a building B (61). Separate local area networks (LAN) (not shown) or Intranets (not shown) are installed in building A (60) and the building B (61) to provide a medium for interchanging data or information between the people who work in the buildings (60, 61). The free-space optical communication system uses two optical antennas (62) mounted respectively on the buildings (60, 61) and connect respectively to the networks to communicate with each other by means of laser beam carriers (not shown) that transmit the information or data in optical signal form.

With reference to FIGS. 3 and 4, each of the optical antennas (62) typically has transmitter optics (not numbered) and receiver optics (not numbered) to allow duplex communications between two optical antennas (62). Conventional transmitter optics or receiver optics comprises a housing (621), an optical transceiver (622), a convex lens (623) with a focus (not numbered) and a protective window (624). The housing (621) has a front opening (not numbered). The protective window (624) is mounted in the housing (621) adjacent to the front opening to protect the inside of the housing (621) from moisture, contaminants or other materials that would otherwise enter the housing (621) and has an inner side (not numbered). The convex lens (623) is mounted in the housing (621) at the inner side of the protective window (624). The optical transceiver (622) is mounted in the housing (621) at the focus of the convex lens (623) and transmits or receives parallel laser beam carriers that are refracted through the convex lens (623).

However, the convex lens (623) is typically made of glass with a high transmission rate of light and must have an exact curvature and smooth surface on both sides. The glass with a high transmission rate of light is expensive to manufacture. Besides, machining the glass to form an exact curvature and smooth surface at both sides of the convex lens (623) is not easy to achieve such that a maximum size of the convex lens (623) is restricted. Fabricating a very large convex lens (623) is almost impossible. However, the size of the convex lens (623) will directly effect how far laser beam carriers transmit and how efficiently the convex lens (623) converges the laser beam carriers.

To overcome the shortcomings, the present invention provides a reflective optical apparatus for a free-space optical communication system to mitigate or obviate the aforementioned problems.

### SUMMARY OF THE INVENTION

The main objective of the invention is to provide a reflective optical apparatus for a free-space optical communication system, which is inexpensive and easy to machine in fabrication.

Other objectives, advantages and novel features of the invention will become more apparent from the following detailed description when taken in conjunction with the accompanying drawings.

### BRIEF DESCRIPTION OF THE DRAWINGS

FIG. 1 is a side plan view in partial section of a reflective optical apparatus in accordance with the present invention;

FIG. 2 is an operational perspective view of a free-space link in a free-space optical communication system;

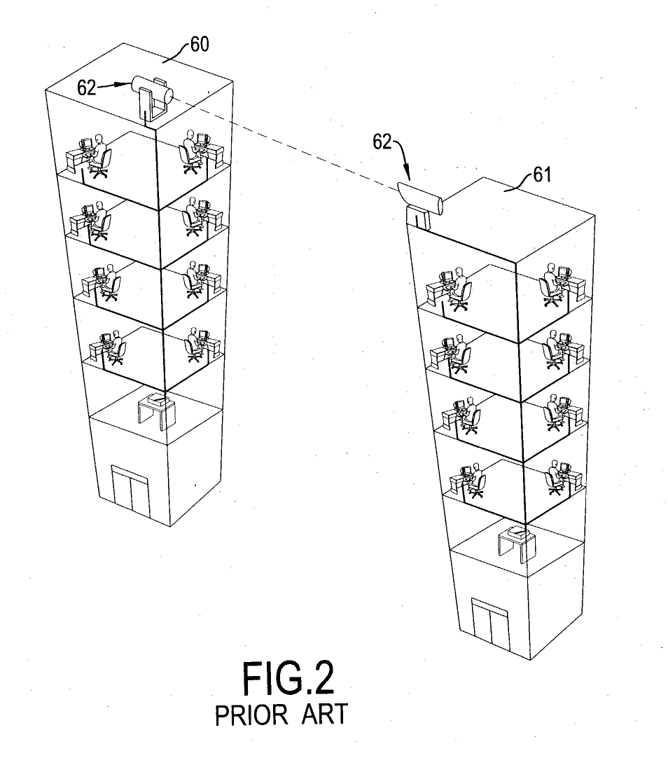

FIG. 3 is a side plan view in partial section of a conventional refractive optical apparatus in accordance with the prior art; and

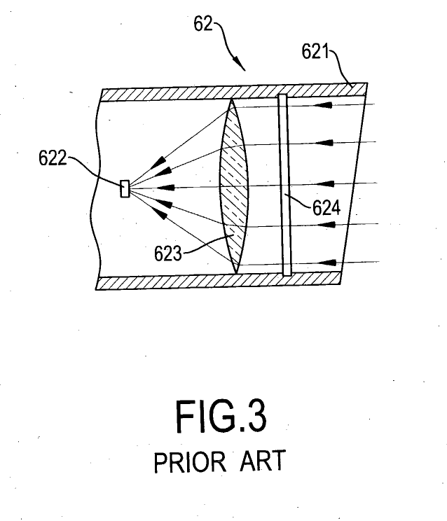

FIG. 4 is a block diagram of an optical antenna device for a free-space link in the free-space optical communication system in FIG. 2.

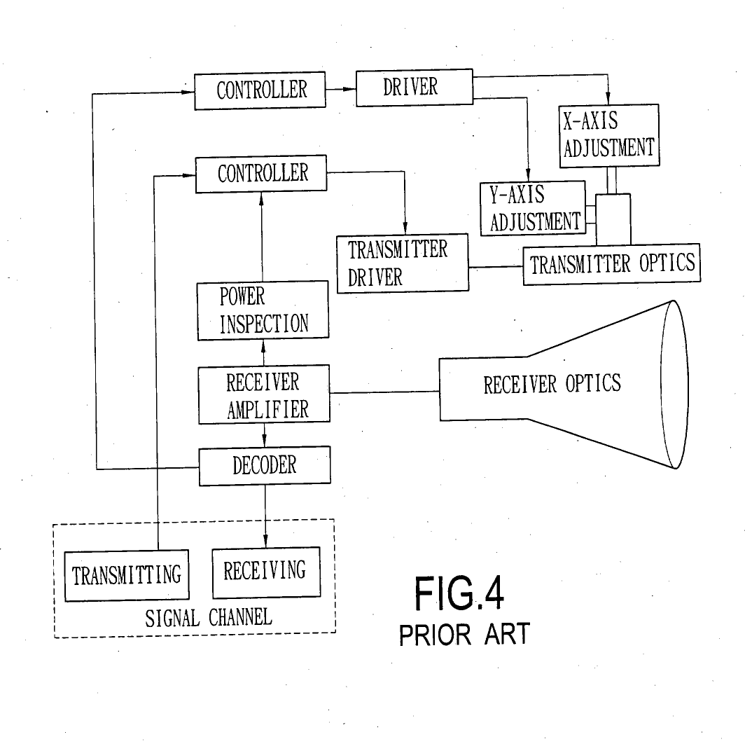

### DETAILED DESCRIPTION OF PREFERRED EMBODIMENT

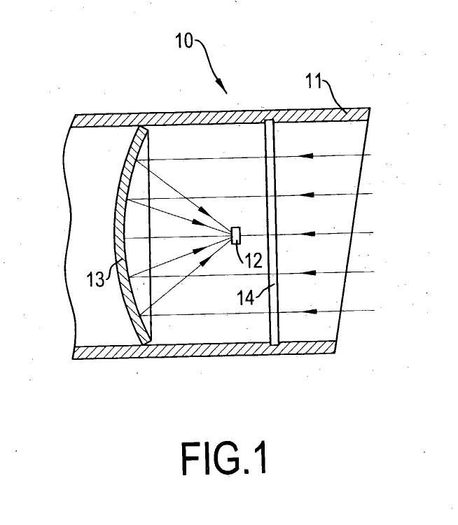

With reference to FIG. 1, a reflective optical apparatus (10) in accordance with the present invention comprises a housing (11), an optical transceiver (12), a reflective member (13) and a protective window (14). The housing (11), the optical transceiver (12) and the protective window (14) are conventional and no further description is provided. The housing (11) has a front opening (not numbered). The reflective member (13) is mounted in the housing (11) and has a concave reflective surface (not numbered) that faces toward the front opening, and the reflective surface will converge parallel laser beam carriers at a focal point (not numbered). The reflective member (13) can be made of easily machinable material, such as plastic or composite materials. Such materials can be precisely machined by computer controlled machining machines to fabricate the reflective member (13) with an exact curvature and smooth surface. Thereafter, the reflective surface can be coated with a layer of highly reflective materials by evaporation or be rubbed with a layer of highly reflective materials. The reflective surface will efficiently reflect and converge the parallel laser beam carriers at its focal point.

The optical transceiver (12) is conventional and is mounted at the focal point of the reflective surface to transmit or receive optical signals, the laser beam carriers that carry the information massages in optical forms. The protective window (14) is mounted in the housing (11) between the optical transceiver (12) and the front opening of the housing (11) to protect the inside of the housing (11) from moisture or contaminants in the environment.

Consequently, since the materials of the reflective member (13) are low cost and machining the reflective member (13) can be performed precisely by computer controlled machining machines, the reflective member (13) can be larger than a conventional refractive lens. The curvature and smoothness of the surface of the reflective surface are controlled and machined precisely to accommodate the requirements of high performance transmission of data in a free-space optical communication system.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A reflective optical apparatus for a free-space optical communication system and the reflective optical apparatus comprising:
a housing having a front opening;
a reflective member mounted in the housing and having a concave reflective surface with a focal point and the concave reflective surface facing the front opening of the housing;
an optical transceiver mounted at the focal point of the concave reflective surface; and
a protective window mounted in the housing between the transceiver and the front opening of the housing.
